(19) United States
(12) Patent Application Publication
(10) Pub. No.: US 2014/0054437 A1
(43) Pub. Date: Feb. 27, 2014

(54) MAST BRACKET

(71) Applicant: Michael V. Kalavitz, Allegan, MI (US)

(72) Inventor: Michael V. Kalavitz, Allegan, MI (US)

(21) Appl. No.: 13/943,775

(22) Filed: Jul. 16, 2013

Related U.S. Application Data
(60) Provisional application No. 61/671,931, filed on Jul. 16, 2012.

(51) Int. Cl. F16M 13/02

(52) U.S. Cl. CPC F16M 13/02
USPC 248/534; 29/525.11

(57) ABSTRACT

Disclosed is a mast bracket for limiting the whipping or reciprocating movement of a mast-like device comprising: a mast bracket base; a mast bracket arm connected to the mast bracket base; a mast bracket restraint tab connected to the mast bracket arm; a mast bracket restraint slot disposed in the mast bracket restraint tab; and a bracket base slot disposed in the mast bracket base.

### CROSS REFERENCE TO RELATED APPLICATION

The present Application is related to Provisional Patent Application entitled “Mast Bracket,” filed 16 Jul. 2012 and assigned filing Ser. No. 61/671,931, incorporated herein by reference in its entirety.

### FIELD OF THE INVENTION

The present invention relates generally to restraint devices and, more specifically, to a mast bracket suitable for use in restraining a mast-like assembly or an antenna-like assembly.

### BACKGROUND OF THE INVENTION

It is known in the art to utilize a mast assembly on a vehicle, where the mast assembly may comprise an antenna or mast or flexible rod, a safety flag, a mounting spring, and/or a safety light. The mast assembly is typically deployed in an erect, or substantially vertical, position while in use. It has been observed that when the vehicle is in motion with a vertically-deployed mast assembly, the mast assembly may bend and whip about as a result of opposing forces on the mast assembly while on the moving vehicle. This whipping action may cause adverse visibility effects of the mast assembly when the vehicle is moving, and may produce wear and tear on the mast assembly over a period of time. The disclosed mast bracket functions to limit or mitigate such whipping action, stabilize the mast assembly, and thus improve the visibility of the mast safety flag whip assembly during vehicle travel and may help to lengthen the useful lifetime of the mast assembly.

### BRIEF SUMMARY OF THE INVENTION

In one aspect of the present invention, a mast bracket suitable for limiting the whipping or reciprocating movement of a mast-like device comprises: a mast bracket base; a mast bracket arm connected to the mast bracket base; a mast bracket restraint tab connected to the mast bracket arm; a mast bracket restraint slot disposed in the mast bracket restraint tab; and a bracket base slot disposed in the mast bracket base.

In another aspect of the present invention, a method of stabilizing a mast-like device onto a support structure comprises the steps of: providing a mast bracket having a cross section generally in the shape of a truncated rectangular frame, the mast bracket including a mast bracket base, a mast bracket arm connected to the mast bracket base, and a mast bracket restraint tab connected to the mast bracket arm; sliding a bracket base slot in the mast bracket base over a mounting hole in the support structure; placing the base coil spring assembly between the mast bracket base and the mast bracket restraint tab; removably securing the hex sleeve inside a mast bracket restraint slot in the mast bracket restraint tab; inserting a threaded mechanical fastener through the mounting hole to engage the base coil spring assembly; and tightening the threaded mechanical fastener so as to place the mast bracket base into a state of compression between the support structure and the base coil assembly.

### BRIEF DESCRIPTIONS OF THE DRAWINGS

The uses and advantages of the present invention will be more fully appreciated as the same becomes better understood from the following detailed description of the present invention when viewed in conjunction with the accompanying Figures, in which:

FIG. 1 is a diagrammatical view of an exemplary embodiment of a mast bracket mounted on a vehicle and restraining the lower end of an antenna or mast assembly, in accordance with the present invention;

FIG. 2 is a diagrammatical view of the mast bracket of FIG. 1 with the top of the antenna or mast assembly in a tied-down configuration;

FIG. 3 is an isometric illustration of the mast bracket of FIG. 1 with the antenna or mast assembly emplaced in the mast bracket;

FIG. 4 is a side view of the mast bracket of FIG. 2, as may be secured to the vehicle with a fastening bolt;

FIG. 5 is an isometric illustration of the mast bracket of FIG. 2 showing a mast bracket restraint slot and a bracket base slot; and

FIG. 6 is a top view of the mast bracket of FIG. 4 showing an offset feature of the mast bracket restraint slot.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. A mast bracket is disclosed, suitable for use in restraining movement of a mast-like pole secured to a support structure.

Certain terminology may be used in the following description for convenience and reference only, and will not be limiting. For example, the phrases “connected to,” “secured to,” or similar language include the definitions “indirectly connected to,” “directly connected to,” “indirectly secured to,” and “directly secured to.”

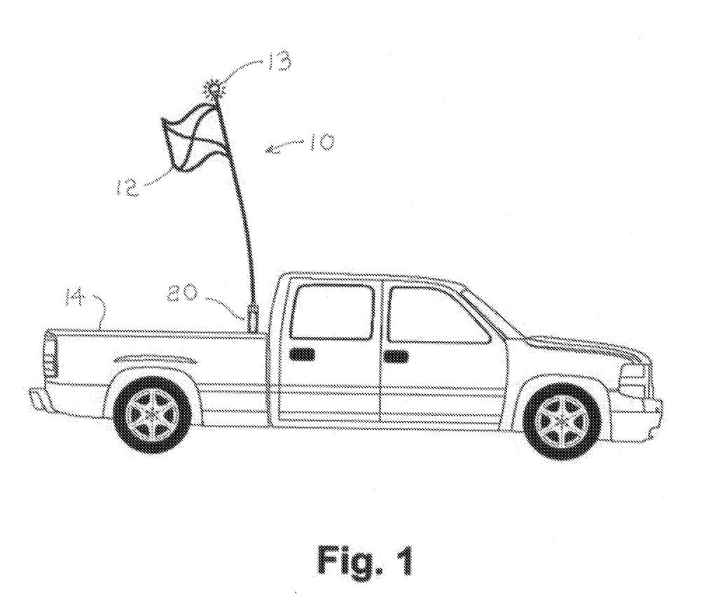

A typical application of a mast bracket 20, in accordance with the present invention, is shown in the diagrammatical illustration of FIG. 1. The mast bracket 20 functions to restrain the lower end or base section of a mast, a mast-like device, or an antenna assembly 10 (shown in FIG. 1), which may include a flag 12, a banner, or safety light 13, for example, on a fiberglass rod 18. The antenna assembly 10 is typically mounted to a support structure 14, here shown as the side panel of a motor vehicle. The mast bracket 20 may be adapted for use on other support structures such as, for example, a boat, a military tank, a wheel chair, a hospital bed, a mine shaft cart, or a space ship. The mast bracket 20 functions to limit whipping or reciprocating movement of the antenna assembly 10 relative to the surface of the support structure 14.

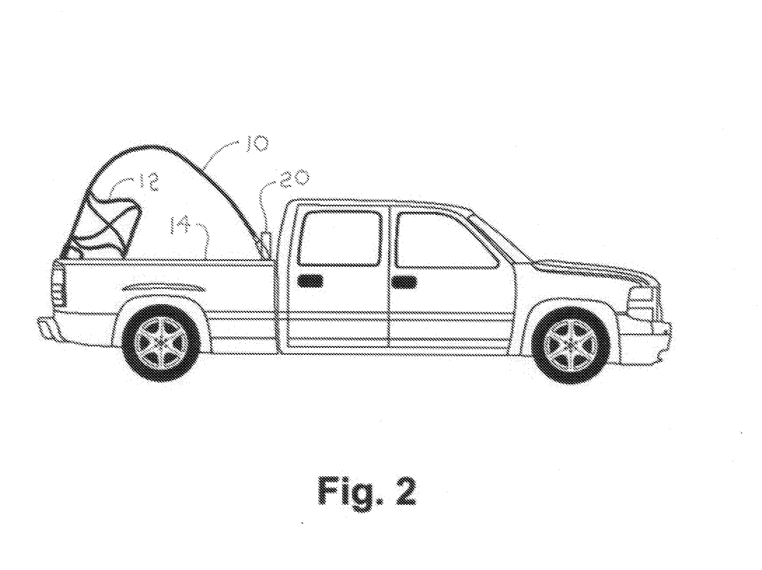

As shown in FIG. 2, the upper end of the antenna assembly 10 may also be secured to the support structure 14 under certain modes of operation, or when the antenna assembly 10 is being stowed. Accordingly, the lower end of the antenna assembly 10 may be removed or released from the mast bracket 20 to more easily allow the antenna assembly 10 to be brought downward for stowing, as shown.

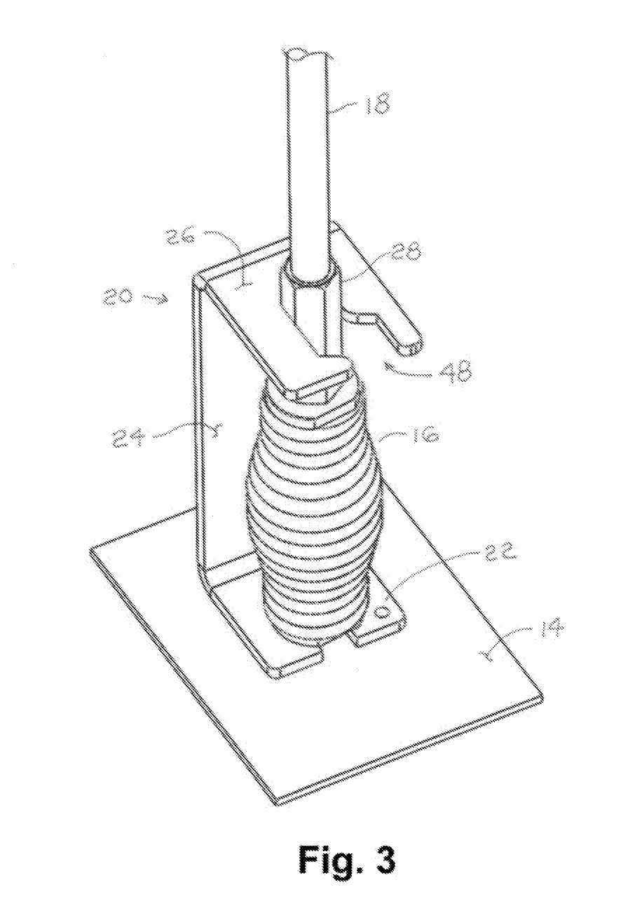

As shown in FIG. 3, the supporting end of the mast or antenna assembly 10 may include a base coil spring assembly 16 as is well known in the art. The mast bracket 20 may be attached to the support structure 14 by means of a mast bracket base 22, as described in greater detail below. The mast bracket 20 includes a mast bracket arm 24 extending approximately 90° from the mast bracket base 22, with a mast bracket restraint tab 26 extending approximately 90° from the mast bracket arm 24. The mast or antenna assembly 10 may be supported with the hex sleeve 28 secured within a mast bracket restraint slot 48 in the mast bracket restraint tab 26.

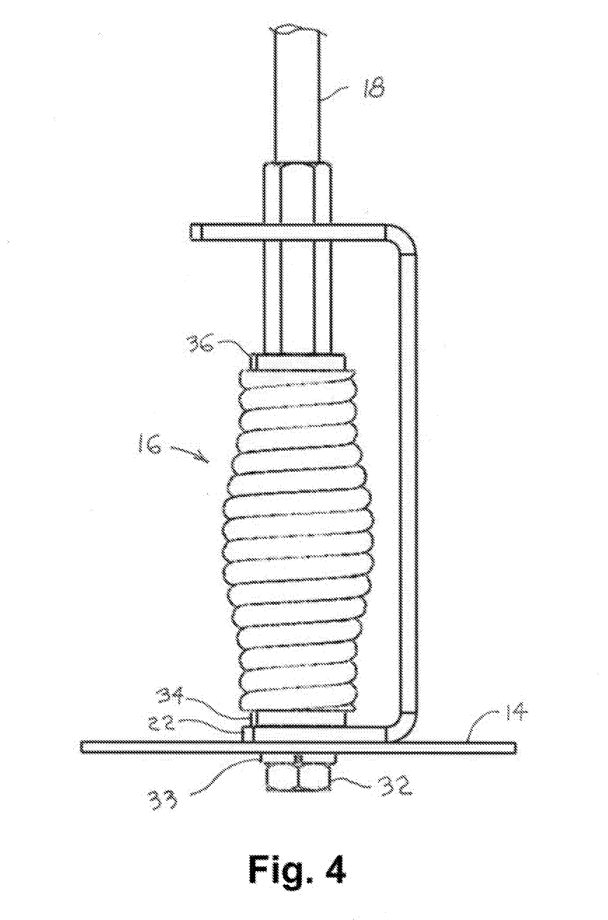

The mast bracket base 22, the mast bracket arm 24, and the mast bracket restraint tab 26 thus form a substantially truncated rectangular frame shape (i.e., a generally C-shaped component) with rounded corners, as seen more clearly in FIG. 4. Alternatively, the mast bracket arm 24 may be slightly curved, rather than flat, to provide a more pleasing appearance. The mast bracket 20 may be formed as a single, integral component from a heavy gauge metal sheet, and is preferably corrosion-resistant.

Alternatively, the mast bracket base 22, the mast bracket arm 24, and the mast bracket restraint tab 26 may be welded into a unitary part, as is known in the art. The widths of the mast bracket base 22 and the mast bracket restraint tab 26 are sufficiently wide so as to provide structural support even with the mast bracket restraint slot 48 and the bracket base slot 46 formed in the mast bracket 20 as shown.

As shown in the side view of FIG. 4, the fiberglass rod 18 may be connected to one end of the base coil spring assembly 16 by means of an upper spring termination 36. The opposite end of the base coil spring assembly 16 may be mounted to the support structure 14 by means of a threaded mechanical fastener, such as a fastening bolt 32, configured to pass through a mounting hole (not shown) in the support structure 14 and engage a lower spring termination 34. A base washer and optional lock washer 33 may be used with the fastening bolt 32 prior to attachment to the lower spring termination 34. The fastening bolt 32 is tightened so as to place the mast bracket base into a state of compression between the support structure and the base coil assembly.

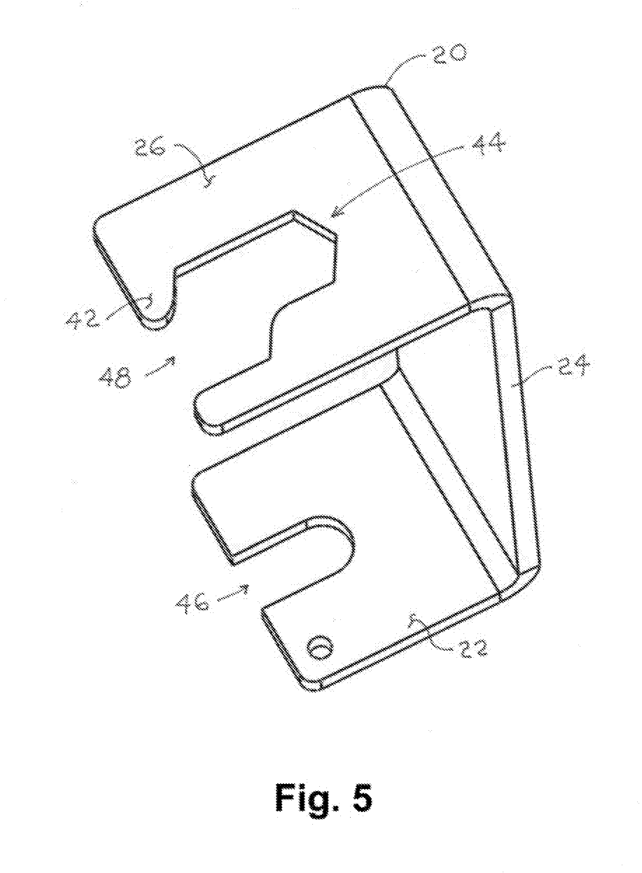

Before the mast or antenna assembly 10 is securely mounted to the support structure 14, the mast bracket base 22 may be emplaced between the lower spring termination 34 and the support structure 14, by sliding the fastening bolt 32 into a bracket base slot 46, shown in FIG. 5 below. Alternatively, the mast bracket base 22 may include a through-hole (not shown) in place of the bracket base slot 46, the through-hole being sized to allow the fastening bolt 32 to pass therethrough.

FIG. 5 is an isometric view of the mast bracket 20. The hex sleeve 28 may be guided into the mast bracket restraint slot 48 by the user, and may thus be removably secured in a bracket tab hex recess 44, as shown in FIGS. 3 and 5. In an exemplary embodiment, the bracket tab hex recess 44 is shaped and sized so as to accommodate four sides of a hexagonal component. Accordingly, the bracket tab hex recess 44 bears against substantially four sides of the hex sleeve 28. A bracket tab ear 42 is disposed at an opening of the mast bracket restraint slot 48. The bracket tab ear 42 is sized and configured so as to prevent the mast or antenna assembly from being inadvertently flung out of the mast bracket restraint slot 48. Accordingly, the mast or antenna will remain within the mast bracket restraint slot 48 unless intentionally removed by a user.

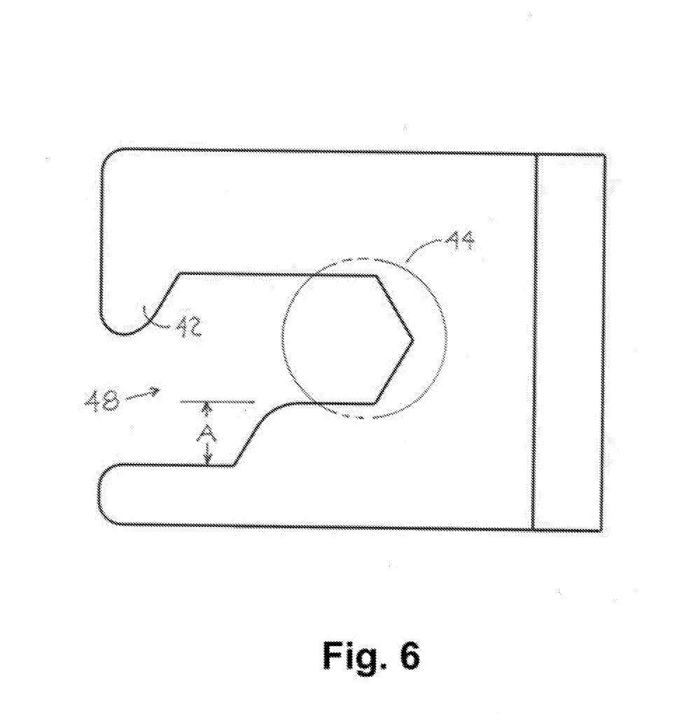

As shown in FIG. 6, the bracket tab hex recess 44 may be offset by a pre-determined distance from the opening of the mast bracket restraint slot 48, the amount of offset here denoted as dimension “A”. This offset feature, along with the bracket tab ear 42, both function to more positively secure the hex sleeve 28 in the bracket tab hex recess 44. In addition, the bending and compression actions of the base coil spring 16 serves to more positively force the mast or antenna assembly 10 into the mast bracket restraint slot 48.

The mast bracket arm 24 is specified to be of sufficient length such that the mast bracket restraint tab 26 may engage the hex sleeve 28 when the mast bracket base 22 is positioned at the lower end of the base coil spring 16. The mast bracket base 22 includes the bracket base slot 46, sized and located to fit around the fastening bolt 32 of the antenna assembly 10, for example, upon mounting the antenna assembly 10 onto the support structure 14, as shown in FIG. 4.

It is to be understood that the description herein is exemplary of the invention only and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

Furthermore, what has been described and illustrated herein are exemplary embodiments of the invention. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated.

What is claimed is:

1. A mast bracket suitable for limiting the whipping or reciprocating movement of a mast-like device, said mast bracket comprising:
a mast bracket base;
a mast bracket arm connected to said mast bracket base;
a mast bracket restraint tab connected to said mast bracket arm;
a mast bracket restraint slot disposed in said mast bracket restraint tab; and
a bracket base slot disposed in said mast bracket base.

2. The mast bracket of claim 1 wherein said mast bracket base, said mast bracket arm, and said mast bracket restraint tab comprise a single, unitary component.

3. The mast bracket of claim 1 wherein said mast bracket restraint tab comprises a bracket tab ear disposed at an opening of said mast bracket restraint slot, said bracket tab ear sized and configured so as to prevent the mast-like device from being inadvertently flung out of said mast bracket restraint slot.

4. The mast bracket of claim 1 wherein said mast bracket base, said mast bracket arm, and said mast bracket restraint tab are formed from metal sheet.

5. The mast bracket of claim 1 wherein said mast bracket arm extends at substantially 90° from said mast bracket base.

6. The mast bracket of claim 1 wherein said mast bracket arm extends at substantially 90° from said mast bracket restraint tab.

7. The mast bracket of claim 1 wherein said mast bracket restraint slot comprises a bracket tab hex recess, said bracket tab hex recess sized and shaped to removably secure within said mast bracket restraint tab a hex sleeve forming part of the mast-like device.

8. A method of stabilizing a mast-like device onto a support structure, the mast-like device having a hex sleeve securing a flexible rod to a base coil spring assembly, said method comprising the steps of:
providing a mast bracket having a cross section generally in the shape of a truncated rectangular frame, said mast bracket including a mast bracket base, a mast bracket arm connected to said mast bracket base, and a mast bracket restraint tab connected to said mast bracket arm;
sliding a bracket base slot in said mast bracket base over a mounting hole in the support structure;
placing the base coil spring assembly between said mast bracket base and said mast bracket restraint tab;
removably securing the hex sleeve inside a mast bracket restraint slot in said mast bracket restraint tab;
inserting a threaded mechanical fastener through said mounting hole to engage the base coil spring assembly; and
tightening said threaded mechanical fastener so as to place said mast bracket base into a state of compression between the support structure and the base coil assembly.

9. The method of stabilizing a mast-like device as in claim 8 wherein said mast bracket base, said mast bracket arm, and said mast bracket restraint tab comprise a single, unitary component.
